(19) United States
(12) Patent Application Publication
(10) Pub. No.: US 2016/0351920 A1
(43) Pub. Date: Dec. 1, 2016

(54) SEAL STABILIZER

(71) Applicant: GM Global Technology Operations LLC, Detroit, MI (US)

(72) Inventor: Yeh-Hung Lai, Oakland, MI (US)

(21) Appl. No.: 14/723,522

(22) Filed: May 28, 2015

(51) Int. Cl. H01M 8/02

(52) U.S. Cl. CPC H01M 8/0276; H01M 8/0258; H01M 2250/20

(57) ABSTRACT

A fuel cell system and a method of assembling a fuel cell system. The system is made up of numerous fluid-conveying plate assemblies stacked such that seals are placed between adjacent plates. Seal stabilizers are placed adjacent at least one of the seals on each plate to reduce the tendency of a moment produced by the compressive force of the stack onto the seals to cause an angular orientation to between adjacent ones of the plates within the stacked assemblies. In one form, the stabilizers produce an interference fit to counteract the moment.

### BACKGROUND OF THE INVENTION

The present invention relates generally to an apparatus and method for improved reactant and coolant flow sealing within fluid-delivery plates used in a fuel cell assembly, and more particularly to the use of a seal stabilizer to counteract the tendency of misaligned plate stacks to form gaps in such seals.

Fuel cells convert a fuel into usable energy via electrochemical reaction. A significant benefit to such an approach is that it is achieved without reliance upon combustion as an intermediate step. As such, fuel cells have several environmental advantages over internal combustion engines (ICEs) for propulsion and related motive applications. In a typical fuel cell—such as a proton exchange membrane or polymer electrolyte membrane (in either event, PEM) fuel cell—a pair of catalyzed electrodes are separated by an ion-transmissive medium (such as Nafion™) in what is commonly referred to as a membrane electrode assembly (MEA). The electrochemical reaction occurs when a first reactant in the form of a gaseous reducing agent (such as hydrogen, H₂) is introduced to and ionized at the anode and then made to pass through the ion-transmissive medium such that it combines with a second reactant in the form of a gaseous oxidizing agent (such as oxygen, O₂) that has been introduced through the other electrode (the cathode); this combination of reactants form water as a byproduct. The electrons that were liberated in the ionization of the first reactant proceed in the form of direct current (DC) to the cathode via external circuit that typically includes a load (such as an electric motor, as well as various pumps, valves, compressors or other fluid delivery components) where useful work may be performed. The power generation produced by this flow of DC electricity can be increased by combining numerous such cells into a larger current-producing assembly. In one such construction, the fuel cells are connected along a common stacking dimension in the assembly—much like a deck of cards—to form a fuel cell stack.

In such a stack, adjacent MEAs are separated from one another by a series of reactant flow channels, typically in the form of a gas impermeable, electrically conductive bipolar plates. In one common form, the channels are of a generally serpentine layout, although other forms—including those with generally straight or sinusoidal patterns—may also be used. Regardless of the channel shape, it covers the majority of the opposing generally planar surfaces of each plate. The juxtaposition of the plate and MEA promotes the conveyance of one of the reactants to or from the fuel cell, while additional channels (that are fluidly decoupled from the reactant channels) may also be used for coolant delivery. In one configuration, the bipolar plate is itself an assembly formed by securing a pair of thin metal sheets (called half plates) that have the channels stamped or otherwise integrally formed on their surfaces, while in another, the assembly includes an additional interstitial sheet with channels to put coolant into thermal communication with the adjacent anode and cathode channels of the outer sheets. Regardless of whether the assembly is two-sheet or three-sheet variety, the various reactant and coolant flowpaths formed by the channels on each of these sheets typically convene at a manifold (also referred to herein as a manifold region or manifold area) defined on one or more opposing edges of the plate. Examples of all of these features - as well as a typical construction of such bipolar plate assemblies that may be used in PEM fuel cells - are shown and described in commonly-owned U.S. Pat. Nos. 5,776,624 and 8,679,697, the contents of which are hereby incorporated by reference.

It is important to avoid leakage and related disparate fluid crosstalk within a PEM fuel cell stack. In particular, the cross-sectional area of a flow channels formed on the surface of the plates is significantly smaller than that of the fluidly-coupled manifold. As such, the reactants or coolant entering the flow channels from the corresponding manifold experience a significant pressure rise. To mitigate against leakage of such high pressure fluids, seals (typically in the form of an elastomeric seal bead, gasket or the like) may be placed between adjacent bipolar plates. In one form, the plates may include grooves or related channels in the form of sub-gaskets that are formed within the surface. In such construction, these grooves that can accept a seal therein are generally similar to that of the previously-mentioned flowpath channels, and are especially prevalent around the various apertures that are formed within the headers or manifolds, as well as around the plate center that corresponds to the active area defined by the MEA. In other configurations, the grooves are not required. In such construction, variations in the dimension of the seals would have additional flexibility. Regardless of whether the seals are configured to cooperate with grooved or non-grooved surfaces, by virtue of their constituent materials (for example, resilient elastomer-based compounds), the gasket and seals may also provide electrical insulation between the anode and cathode sides of the plates.

Ideally, these seals form good fluid-tight connections between adjacent plates once compression and subsequent stack assembly has been completed. In practice, even slight plate misalignment leads to out-of-plane rotation between adjacent plates that leads to variations in pressure applied to the corresponding seals, resulting in gaps being formed in the seals, while more severe misalignment may result in seal failure (such as through buckling or the like). It would be desirable to reduce seal misalignment and resulting plate rotation that harms the ability of the seals to perform their fluid-containment functions.

### SUMMARY OF THE INVENTION

It is an object of the disclosure to provide a seal stabilizer that will mitigate the impact of seal-to-seal misalignment that may be due to plate-to-plate misalignment in configurations where the seal is attached to the plate, MEA-to-MEA misalignment in configurations where the seal is attached to an MEA-based sub-gasket, as well as simply seal-to-seal misalignment in configurations where the seal is not attached to either a plate or the MEA. The present inventor observed that control of seal misalignment and free rotation between plates may help to achieve such seal stabilization. For example, buckling of the seal is more likely to happen when the seal-to-seal misalignment along the stacking axis is greater, as this creates plate tilting (i.e., rotation) near its unsupported/cantilevered edges. In one form, this can take place around an outer edge, while in another, around the headers or along the long edge around the cell active area. This in turn tends to form an angle for the seal compressive force that then leads to a horizontal (i.e., in-plane) force that has a tendency to push the seal out of its intended placement, especially when the friction or adhesion between the seal and groove is low. The present inventor has further determined that this creates an eccentricity that can lead to an incompressible deformation and subsequent buckling of the seal.

According to one aspect of the present invention, a fuel cell system includes a stack made up of numerous cells each of which includes an MEA cooperative with a plate that may be part of a bipolar plate or related multi-plate assembly. The plate defines one or more fluid channels formed on its surface for the flow of coolant or reactant thereacross. One or more seals are placed on surfaces of the plate along the plate stacking axis such that the repeating seal arrangement is generally aligned, while a seal stabilizer is included to meliorate the effect of sealing offsets due to any misalignment between the stacked assemblies. The seal stabilizer is placed near to the seal in order to resist any tendency by a moment couple (also called force couple) produced by the compressive force of the stack onto the seals to cause an angular (i.e., non-parallel) orientation to between adjacent ones of the plates within the stacked configuration. In one preferred embodiment, the seal is placed substantially coplanar with the stabilizer, while in another preferred embodiment, the seal and the stabilizer are formed on the same plate surface. In yet another preferred embodiment, a sub-gasket may form or be cooperative with the MEA such that the stabilizer is attached to it to achieve the aforementioned reduction or elimination of MEA-to-MEA misalignment.

According to another aspect of the present invention, a method of assembling a fuel cell system includes placing numerous fuel cells on top of one another in a stacked configuration and placing a seal stabilizer in cooperative engagement with the seal such that the stabilizer inhibits misalignment-induced rotation between adjacent plates within the stack. In particular, the plates that provide structural support and fluid delivery to a respective MEA have a tendency upon stacking misalignment to impart in-plane forces as well as out-of-plane rotational forces to adjacent bipolar plates; the inclusion of the stabilizers in substantially coplanar locations that are adjacent the seals—while not preventing the misalignment itself—at least mitigates the effects of such misalignment by providing enough of an interference fit to resist such in-plane and rotational tendencies.

According to yet another aspect of the present invention, a method of preventing seal buckling within an assembled fuel cell system includes placing numerous fuel cells on top of one another in a stacked configuration and placing a seal stabilizer in cooperative engagement with the seal such that the misalignment-based rotation between adjacent ones of the bipolar plates within the stacked configuration is reduced at least along an axial dimension defined by the seal to an extent that avoids a fluid-liberating deformation therein. In the present context, buckling is understood to be a phenomena that manifests itself predominantly along the elongate dimension of a structure. With particular regard to the seals used between bipolar plates, the aspect ratio of the seal is such that it is far longer (often by orders of magnitude) along its axial dimension than they along the radial or lateral dimension. As such, the occurrence of buckling is likely to manifest itself as a bend, hump or related undulation being formed along at least a portion of the length of the seal such that a gap that in turn permits the relatively unimpeded leakage of the fluid that the seal was designed to contain.

These and other objects, features, embodiments, and advantages will become apparent to those of ordinary skill in the art from a reading of the following detailed description and the appended claims.

### BRIEF DESCRIPTION OF THE DRAWINGS

The following detailed description of the preferred embodiments of the present invention can be best understood when read in conjunction with the following drawings, where like structure is indicated with like reference numerals and in which the various components of the drawings are not necessarily illustrated to scale:

FIG. 1 is a illustration of a partially exploded, sectional view of a portion of a simplified fuel cell with surrounding bipolar plates;

FIG. 2 is a simplified isometric, exploded view of a bipolar plate assembly that can be used in accordance with the present invention;

FIGS. 3A and 3B show simplified edge-on and perspective views respectively of an ideal alignment between adjacent seals;

FIGS. 4A and 4B show the effects of slight misalignments within a planar dimension of the seals of FIGS. 3A and 3B;

FIGS. 5A and 5B show the placement of stabilizers to meliorate the impact of misalignment on the seals of FIGS. 4A and 4B; and

FIG. 6 shows how a misaligned seal can buckle without the stabilizers of FIGS. 5A and 5B.

### DETAILED DESCRIPTION OF THE EMBODIMENTS

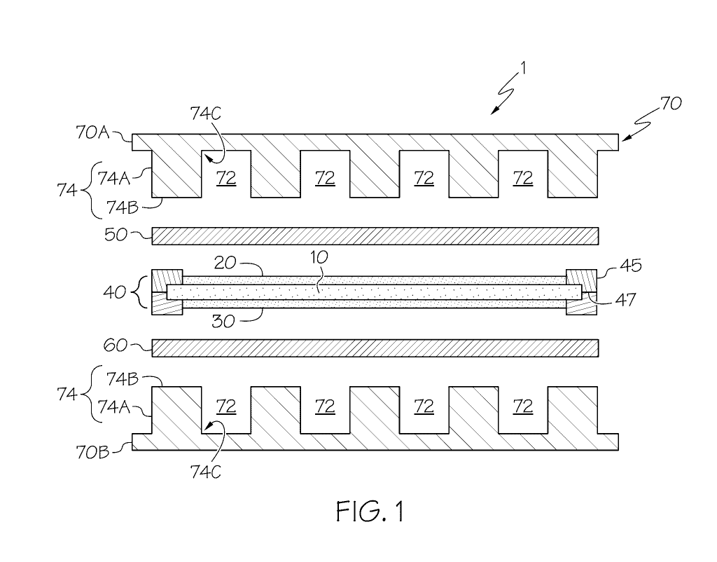

Referring initially to FIG. 1, a simplified view of a PEM fuel cell 1 in exploded form is shown. The fuel cell 1 includes a substantially planar proton exchange membrane 10, anode catalyst layer 20 in facing contact with one face of the proton exchange membrane 10, and cathode catalyst layer 30 in facing contact with the other face. Collectively, the proton exchange membrane 10 and catalyst layers 20 and 30 are referred to as the MEA 40. An anode diffusion layer 50 is arranged in facing contact with the anode catalyst layer 20, while a cathode diffusion layer 60 is arranged in facing contact with the cathode catalyst layer 30. Each of diffusion layers 50 and 60 are made with a generally porous construction to facilitate the passage of gaseous reactants to the catalyst layers 20 and 30. Collectively, anode catalyst layer 20 and cathode catalyst layer 30 are referred to as electrodes, and can be formed as separate distinct layers as shown, or in the alternate (as mentioned above), as embedded at least partially in diffusion layers 50 or 60 respectively, as well as embedded partially in opposite faces of the proton exchange membrane 10. As mentioned above, sub-gaskets may be used to promote seal attachment or related cooperation with the plate (discussed in more detail below); in one form, sub-gasket 45 may be in the form of a plastic frame and plaed peripherally to protect the edge of the MEA 40. This sub-gasket 45 is often used to extend the separation of gases and electrons between the catalyst layers 20 and 30 to the edge of MEA 40, and is often placed where the elastomeric seal (discussed below) comes into contact with the MEA 40. This helps reduce overboard leaks of reactant gases and coolant, as well as their inter-mixing at the manifold region. In some cases, the elastomeric seal can be attached or directly formed onto the sub-gasket 45 as part or extension of the MEA 40; either variant is deemed to be within the scope of the present invention, as are variants where the seal is directly mounted to the plate or other structure.

In addition to providing a substantially porous flowpath for reactant gases to reach the appropriate side of the proton exchange membrane 10, the diffusion layers 50 and 60 provide electrical contact between the electrode catalyst layers 20, 30 and a bipolar plate 70 that in turn acts as a current collector. Moreover, by its generally porous nature, the diffusion layers 50 and 60 also form a conduit for removal of product gases generated at the catalyst layers 20, 30. Furthermore, the cathode diffusion layer 60 generates significant quantities of water vapor in the cathode diffusion layer. Such feature is important for helping to keep the proton exchange membrane 10 hydrated. Water permeation in the diffusion layers can be adjusted through the introduction of small quantities of polytetrafluoroethylene (PTFE) or related material.

Although shown notionally as having a thick-walled structure, bipolar plates 70 preferably employ a thin-walled structure (as will be shown and described in more detail below); as such, FIG. 1 should not be used to infer the relative thickness between the channels 72 and the plate structure that gives definition to such channels. Simplified opposing surfaces 70A and 70B of a pair of bipolar plates 70 are provided to separate each MEA 40 and accompanying diffusion layers 50, 60 from adjacent MEAs and layers (neither of which are shown) in a stack that may be subsequently compressed along the stacking axis and placed into a housing or related enclosure. One plate 70A engages the anode diffusion layer 50 while a second plate 70B engages the cathode diffusion layer 60. Each plate 70A and 70B (which upon assembly as a unitary whole would make up the bipolar plate 70) defines numerous reactant gas flow channels 72 along a respective plate face. Three-dimensional (i.e., out-of-plane) structure 74 is made up of walls 74A and lands 74B that separate adjacent sections of the reactant gas flow channels 72 by projecting toward and making direct contact with the respective diffusion layers 50, 60. Although bipolar plate 70 is shown (for stylized purposes) defining purely rectangular reactant gas flow channels 72 and structure 74, it will be appreciated by those skilled in the art that a more accurate (and preferable) embodiment will be shown below, where generally serpentine-shaped channels 72 (along with their respective generally planar apexes that correspond to the lands 74B) are formed. As mentioned above, the flow channels 72 need not be serpentine, and as such may embody other shapes, including generally straight or sinusoidal-like profiles. In another form (not shown) the sub-gaskets 45 discussed above may be formed as a groove or related indentation directly into the surface of plate 70 to accept the placement of a seal or seal bead (as discussed below) therein; such portion of the plate 70 that includes such a sub-gasket is known as a seal bead region.

In operation, a first gaseous reactant, such as H₂, is delivered to the anode 20 side of the MEA 40 through the channels 72 from plate 70A, while a second gaseous reactant, such as O₂ (typically in the form of air) is delivered to the cathode 30 side of the MEA 40 through the channels 72 from plate 70B. Catalytic reactions occur at the anode 20 and the cathode 30 respectively, producing protons that migrate through the proton exchange membrane 10 and electrons that result in an electric current that may be transmitted through the diffusion layers 50 and 60 and bipolar plate 70 by virtue of contact between the lands 74B and the layers 50 and 60.

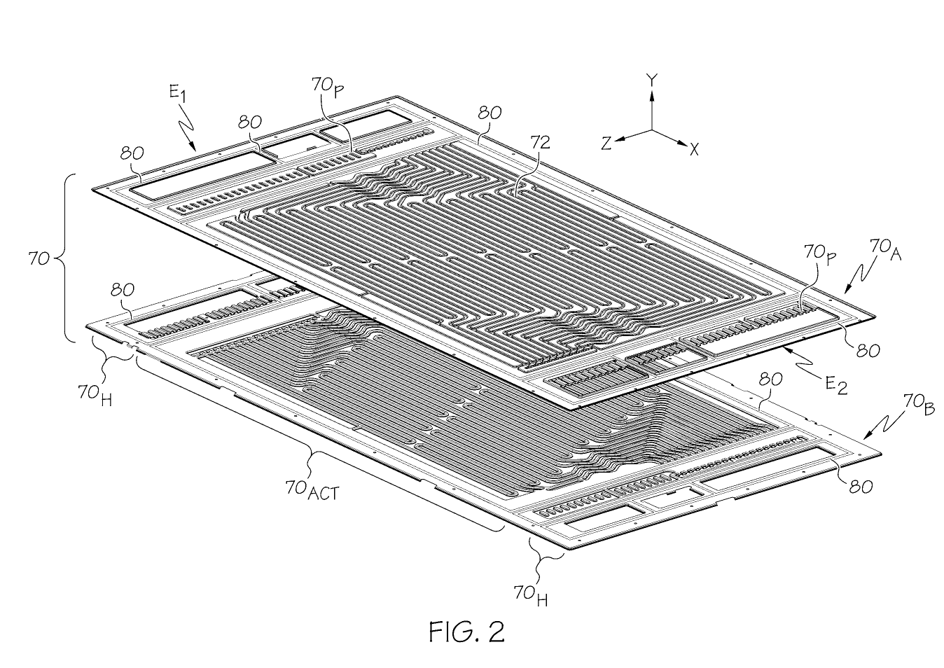

Referring next to FIG. 2, the bipolar plate 70 of FIG. 1 is shown in more detail. In particular, the plate 70 includes both an active area 70_{ACT} and a header area 70_{H}, where the former establishes a planar facing relationship with the electrochemically active area that corresponds to the MEA 40 and diffusion layers 50 and 60 and the latter corresponds an edge (as shown) or peripheral (not shown) area where apertures formed through the plate 70 may act as conduit for the delivery and removal of the reactants, coolant or byproducts to the stacked fuel cells. As shown in FIG. 1, these two plates 70_{A}, 70_{B} may be used to form a sandwich-like structure with the MEA 40 and anode and cathode diffusion layers 50, 60 and then repeated as often as necessary to form a fuel cell stack (not shown). In one form, one or both of the anode plate 70_{A} and cathode plate 70_{B} are made from a corrosion-resistant material (such as 304 SS or the like). The generally serpentine gas flow channels 72 form a tortuous path from near one edge E₁ that is adjacent one header area 70_{H} of the bipolar plate 70 to near the opposite edge E₂ that is adjacent the opposing header area 70_{H}. As can be seen in FIG. 2, the reactant is supplied to channels 72 from a series of repeating gates or grooves that form a port area 70_{P} that lies between the active area 70_{ACT} and the header area 70_{H} of one (for example, supply) edge E₁; a similar configuration is present on the opposite (for example, exhaust) edge E₂. In an alternate embodiment (not shown), the supply and exhaust manifold areas can lie adjacent the same edge (i.e., either E₁ or E₂) of the bipolar plate 70. In situations where the bipolar plate 70 is made from a formable material (such as the aforementioned stainless steel) the various surface features (including the grooves, channels or the like) may be stamped or otherwise formed through well-known techniques.

Seals 80 (which are preferably made from a resilient plastic or elastomers (including polyacrylate, alhydrated chlorosulphonated polyethylene, ethylene acrylic, chloroprene, chlorosulphonated polyethylene, ethylene propylene, ethylene vinyl acetate, perfluoroelastomer, flourocarbon, flourosilicone, hydrogenated nitrile, polyisoprene, microecllular polyurethane, nitrile rubber, natural rubber, polyurethane, styrene-butadiene rubber, TFE/propylene, silicone, carboxylated nitrile or the like) are seated on portions of the plates 70 that are adjacent fluid conduit (such as the apertures in the header area 70_{H}, as well as around the active area 70_{ACT}). In the present context, the stacking dimension of the fuel cell 1 may be along a substantially vertical (i.e., Y) Cartesean axis so that the majority of the surface of each of the bipolar plates 70 is in the X-Z plane that is substantially orthogonal to the stacking axis. Regardless, it will be appreciated by those skilled in the art that the particular orientation of the cells 1, plates 70 and stack isn't critical, but rather provides a convenient way to visualize the placement of the seals 80 and seal stabilizers 90 of the present invention (both shown and described in more detail below), as well as situations where the seals 80 and their respective bipolar plates 70 are or are not ideally aligned with one another.

As mentioned above, one or more groove-like sub-gaskets may be formed into the surface of the bipolar plate 70 to define a seal bead region (not shown). As with the grooves, channels and other features mentioned above, the seal bead regions may be formed by stamping or other forming operations (in configurations where the seal bead region is formed as a groove in the plate surface). In one preferred form, the seal bead regions may define a trough-like shape with a semicircular cross-sectional profile to accommodate a comparably-sized seal 80. The seal bead regions allow placement of a seal 80 therein, where the seal 80 is preferably made from an elastic, compliant material to promote deformability upon compressing two adjacent plates 70 together. As shown seals 80 may be placed around some or all of the active area 70_{ACT}, header area 70_{H} or both to promote fluid-tightness in the regions adjacent the reactant, coolant or byproduct conduit within the stack. As will be shown next,

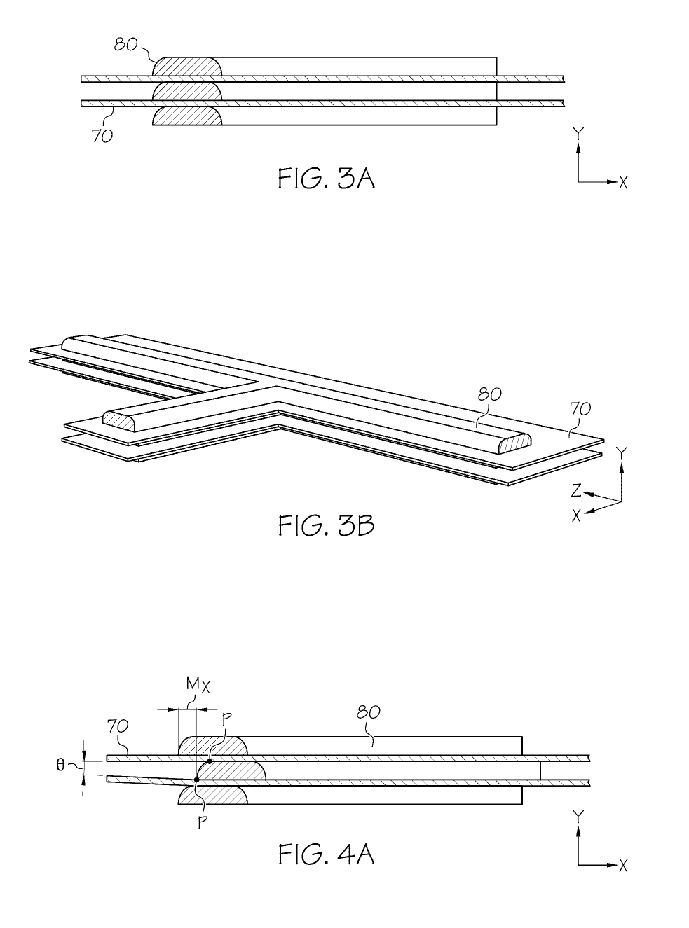

Referring next to FIGS. 3A and 3B in conjunction with the detail region highlighted in FIG. 2, an edge-on view (FIG. 3A) and a perspective view (FIG. 3B) of two plates 70 and their seals 80 are shown in an ideal stacked configuration. In the present context, the stacking between adjacent plates 70 and their seals 80 is deemed to be “ideal” when there is no misalignment between them when stacked in their as-designed orientation. Details associated with an actual bipolar plate 70 (including channels, grooves or related surface undulations) that are shown in FIG. 2 have been omitted from the remaining figures for simplicity. Similarly, a single T-joint (also called a T-shaped joined region) within the highlighted region is shown in FIG. 3B rather than the entire portion of the sealed relationship.

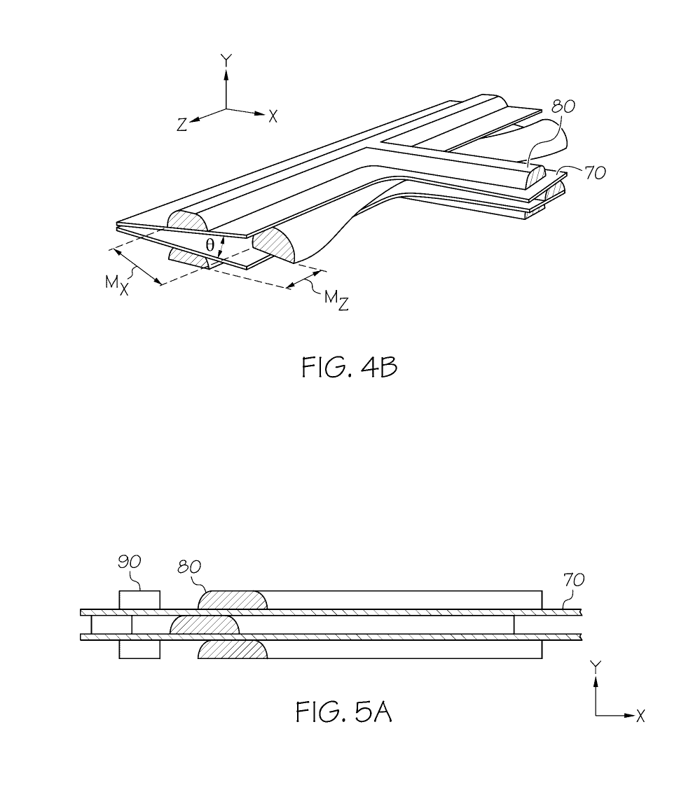

Referring next to FIGS. 4A, 4B and 6, the effect of a misalignment of 1 mm in each of the X and Z axes of the seals 80 is shown. In particular, the misalignment M_{X}, M_{Z} shows how the ordinarily parallel spacing of the adjacent plates 70 becomes angled by an amount in response to the compressive forces from the aligning and stacking process that impart moments via pivot points P formed by partially offset contact between adjacently-compressed seals 80. The rotated plates 70 form the opening angle θ for the seal 80 compressive forces; this in turn creates a horizontal force component (i.e., along the X axis) to push the seal 80 out of place. The resulting in-plane (i.e., X-Z plane as shown) movement of the seal 80 creates compression within it which in turn imparts an axial force along the length direction of the seal 80 due to relative incompressibility of the seal 80,; such compression and resulting forces are present in configurations where the seal is situated on the surface of plate 70, as well as in configurations where the seal 80 is seated within a trough-like groove (not shown) that is formed into the surface of the plate 70 in a manner generally similar to the reactant or coolant channels 72 that were discussed above in conjunction with FIG. 1. This incompressibility can be correlated to the eccentricity condition in an Euler beam buckling problem, where when the axial force in the seal 80 reaches a critical value in conjunction with the eccentricity condition mentioned above, seal 80 instability occurs. As shown with particularity in FIG. 6, this instability leads to a popping out of the seal 80 from its intended location at a buckling point 80B, which in turn results in breaches in the seal 80 perimeter and concomitant overboard leakage of the fluid through such breach. Without wishing to be bound by theory, the inventor belies that the seal 80 buckling problem at buckling point 80B is a function of many parameters, including the overall load, compressive strain, the cross-sectional profile, the nature of the intersection (i.e., T-shaped junctures, regions or the like), length, material/surface properties, adhesion/friction, hyperelasticity, viscoelasticity or the like; some of these factors are discussed in more detail herein.

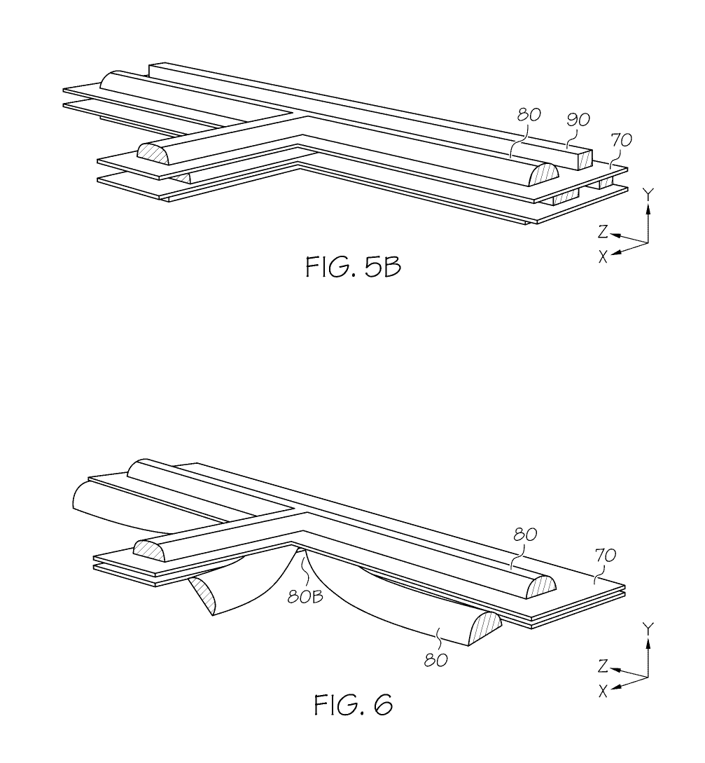

Referring next to FIGS. 5A and 5B, edge-on (FIG. 5A) and perspective (FIG. 5B) views show how the placement of seal stabilizer 90 helps to reduce the misalignment-induced force couple of three adjacently-stacked bipolar plates 70. Significantly, the stabilizer 90—by removing at least a portion of the freedom of rotation of adjacent plates 70—reduces the likelihood that the seal 80 will experience the Euler beam buckling problem. In general, buckling is more likely to occur when the stack compression is higher, the friction/adhesion between the seal 80 and the plate 70 is lower, misalignment is larger (which as mentioned above allows the plate 70 to tilt to form a larger opening angle θ). In one preferred form, the height of the seal stabilizer 90 is between 50% and 150% of the height of the seal 80.

With this cooperative placement between the seals 80 and stabilizers 90, a countering force is set up to reduce the tendency of the plates 70 to rotate. In one form, seal stabilizers 90 may not need to be placed along the entire length or periphery of the plate 70; as such, it may be possible to judiciously place the seal stabilizers 90 (whether in bead or strip form) in locations where plate 70 rotation is expected to be particularly large. In addition to the discussion above where the seal stabilizer 90 can be made of elastomers, plastics or the like, they may also be made from metals that are attached to or formed as part of the bipolar plates 70. In a similar manner (not shown), the seal stabilizers 90 may be attached to the sub-gaskets that themselves can be attached to or even formed as part of the bipolar plates 70. Moreover, the seal stabilizers 90 can take various forms such as beads and strips.

Changes in the coefficients of friction and thermal expansion of the seal 80 material may have an impact on overall seal 80 stability. For example, higher friction is better to maintain the seal 80 in its place. In one form, the material for seal 80 is Henkel 651, while that of the plate 70 material is 304 stainless steel. To determine the suitability of the seal 80 material, assumed coefficients were varied between 0.01, 0.05, 0.75, 0.1 and 0.2. Compression values were set at 20%, 30% (F91), 40% (MRC107), and 50%. Likewise, the tensile strength of the material used in the seals 80 should be high enough to further delay the onset of Euler beam buckling. Moreover, the shape of the seals 80 is important as well, with the inventor discovering that seals 80 that define a circular or semicircular cross-sectional profile tend to perform better than those with rectangular or trapezoidal profiles.

It is noted that terms like “preferably”, “generally” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention, it is noted that the terms “substantially” and “approximately” and their variants are utilized herein to represent the inherent degree of uncertainty that may be attributed to any quantitative comparison, value, measurement or other representation. The term “substantially” is also utilized herein to represent the degree by which a quantitative representation may vary from a stated reference without resulting in a change in the basic function of the subject matter at issue.

Having described the invention in detail and by reference to specific embodiments, it will nonetheless be apparent that modifications and variations are possible without departing from the scope of the invention defined in the appended claims. In particular it is contemplated that the scope of the present invention is not necessarily limited to stated preferred aspects and exemplified embodiments, but should be governed by the appended claims.

I claim:

1. A fuel cell system defining a plurality of fuel cells arranged in a stacked configuration, each of said cells within said system comprising:
a membrane electrode assembly;
a plate placed in fluid cooperation with said membrane electrode assembly, said plate defining at least one fluid channel on a surface thereof;
at least one seal disposed on at least a portion of said plate; and
a seal stabilizer placed in cooperative engagement with said seal such that said stabilizer inhibits misalignment-based rotation between adjacent ones of said plates within said stacked configuration.

2. The fuel cell system of claim 1, wherein said seal is disposed on a substantially planar surface of at least one of said adjacent ones of said plate.

3. The fuel cell system of claim 1, wherein said seal is disposed within a groove formed within at least one of said adjacent ones of said plate.

4. The fuel cell system of claim 1, wherein said seal is disposed on a sub-gasket that is disposed peripherally about said membrane electrode assembly.

5. The fuel cell system of claim 1, wherein said cooperative engagement comprises spacing said stabilizer from said seal substantially within a substantially common plane that is formed between said adjacent ones of said plates.

6. The fuel cell system of claim 5, wherein said seal is disposed on a same plate surface of at least one of said adjacent ones of said plates as said stabilizer.

7. The fuel cell system of claim 1, wherein said portion of said at least one of said adjacent ones of said plates comprises a perimeter region that substantially surrounds said membrane electrode assembly.

8. The fuel cell system of claim 1, wherein said portion of said at least one of said adjacent ones of said plates comprises a manifold region that is in fluid communication with said membrane electrode assembly.

9. The fuel cell system of claim 1, wherein said seal defines at least one joined region therein.

10. The fuel cell system of claim 9, wherein said joined region is substantially T-shaped.

11. The fuel cell system of claim 1, wherein the height of said seal stabilizer is between 50% and 150% of the height of said seal.

12. The fuel cell system of claim 1, wherein said seal stabilizer is affixed to at least one of said plates.

13. The fuel cell system of claim 1, wherein said seal stabilizer is affixed to a sub-gasket that is cooperative with either a respective one of said plates or a respective one of said membrane electrode assemblies.

14. The fuel cell system of claim 13, wherein at least one of said sub-gasket and said seal stabilizer are integrally formed as part of said respective one of said plates.

15. The fuel cell of claim 1, wherein said material is selected from the group consisting of metal, polyacrylate, alhydrated chlorosulphonated polyethylene, ethylene acrylic, chloroprene, chlorosulphonated polyethylene, ethylene propylene, ethylene vinyl acetate, perfluoroelastomer, flourocarbon, flourosilicone, hydrogenated nitrile, polyisoprene, microecllular polyurethane, nitrile rubber, natural rubber, polyurethane, styrene-butadiene rubber, TFE/propylene, silicone and carboxylated nitrile.

16. A vehicle comprising the fuel cell system of claim 1.

17. A method of assembling a fuel cell system, the method comprising:
placing a plurality of fuel cells on top of one another in a stacked configuration, each of said fuel cells comprising:
a membrane electrode assembly;
a plate disposed adjacent said membrane electrode assembly such that at least one of reactant channels and coolant channels formed on a surface of said plate establish fluid communication with a respective anode or cathode of said membrane electrode assembly; and
at least one seal disposed between said plate and said membrane electrode assembly; and
placing a seal stabilizer in cooperative engagement with said seal such that said stabilizer inhibits rotation between adjacent ones of said plates within said stacked configuration.

18. The method of claim 17, further comprising:
compressing said stacked configuration under a compressive load; and
securing said compressed stack within a housing.

19. The method of claim 17, wherein said cooperative engagement comprises spacing said stabilizer from said seal substantially within a substantially common plane that is formed between said adjacent ones of said plates.

20. The method of claim 17, wherein said portion of said at least one of said adjacent ones of said plates is selected from the group consisting of a perimeter region that substantially surrounds said membrane electrode assembly and a manifold region that is in fluid communication with said membrane electrode assembly.

21. A method of preventing seal buckling within an assembled fuel cell system, the method comprising:
placing a plurality of fuel cells on top of one another in a stacked configuration, each of said fuel cells comprising:
a membrane electrode assembly;
a plate disposed adjacent said membrane electrode assembly such that at least one of reactant channels and coolant channels formed on a surface of said plate establish fluid communication with a respective anode or cathode of said membrane electrode assembly; and
at least one seal disposed between said plate and said membrane electrode assembly; and
placing a seal stabilizer in cooperative engagement with said seal such that said misalignment-based rotation between adjacent ones of said plates within said stacked configuration is reduced at least along an axial dimension defined by said seal to an extent that avoids a fluid-liberating deformation therein.
